(19) United States
(12) Patent Application Publication
(10) Pub. No.: US 2005/0220208 A1
(43) Pub. Date: Oct. 6, 2005

(54) Wireless transmitting device and wireless receiving device

(76) Inventor: Tsuguhide Aoki, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/087,601

(22) Filed: Mar. 24, 2005

(30) Foreign Application Priority Data
Mar. 31, 2004 (JP) 2004-107881

(51) Int. Cl. H04L 1/02

(52) U.S. Cl. 375/267

(57) ABSTRACT

A wireless transmitting device for use in communication with a wireless receiving device with a wireless packet, includes a plurality of antennas; and a signal generator configured to generate a signal for the wireless packet being transmitted, the wireless packet comprising a short-preamble sequence, a first long-preamble sequence, a signal field, an AGC preamble sequence, and transmitted in parallel via the plurality of antennas, a second long-preamble sequence, and a data field conveying data, wherein the first signal field includes information at least one of (a) information for notifying transmission of the AGC preambles, (b) information for notifying transmission of the second signal field, the AGC preambles and the data and (c) information for notifying transmission of the AGC preambles and the data using the plurality of antennas.

### CROSS-REFERENCE TO RELATED APPLICATIONS

This application is based upon and claims the benefit of priority from prior Japanese Patent Application No. 2004-107881, filed Mar. 31, 2004, the entire contents of which are incorporated herein by reference.

### BACKGROUND OF THE INVENTION

1. Field of the Invention

The present invention relates to a wireless transmitting device and wireless receiving device for respectively transmitting and receiving wireless signals in mobile communication system like a wireless LAN, using a wireless packet including a preamble and data, and a wireless transmission method and wireless receiving method for use in the devices.

2. Description of the Related Art

The Institute of Electrical and Electronics Engineers (IEEE) is now defining a wireless LAN standard called IEEE 802.11n, which aims to achieve a high throughput of 100 Mbps or more. It is very possible that IEEE 802.11n will employ a technique, called multi-input multi-output (MIMO), for using a plurality of antennas in a transmitter and receiver. IEEE 802.11n is required to coexist with the standard IEEE 802.11a where OFDM (Orthogonal Frequency Division Multiplex) is used. So, it is required that IEEE 802.11n wireless transmitting device and receiving device have so called backwards compatibility.

A proposal presented by Jan Boer et al. in “Backwards Compatibility”, IEEE 802.11-03/714r0, introduces a wireless preamble for MIMO. In this proposal, a short-preamble sequence used for time synchronization, frequency synchronization and automatic gain control (AGC), a long-preamble sequence used to estimate a channel impulse response, a signal field indicating a modulation scheme used in the wireless packet, and another signal field for IEEE 802.11n are firstly transmitted from a single particular transmit antenna. Subsequently, long-preamble sequences are transmitted from the other three transmit antennas. After finishing the transmission of the preamble, transmission data is transmitted from all the antennas.

From the short-preamble to the first signal field, the proposed preamble is identical to the preamble stipulated in IEEE 802.11a where single transmit antenna is assumed. Therefore, when wireless receiving devices that conform to IEEE 802.11a receive a wireless packet containing the Boer's proposed preamble, they recognize that the packet is based on IEEE 802.11a. Thus, the proposed preamble conforming to both IEEE 802.11a and IEEE 802.11n enables IEEE 802.11a and IEEE 802.11n to coexist.

Generally, in wireless receiving devices, demodulation of a received signal is performed by digital signal processing. Therefore, an analog-to-digital (A/D) converter is provided in the devices for quantizing a received analog signal. A/D converters have an input dynamic range (an allowable level range of analog signals to be converted). Accordingly, it is necessary to perform automatic gain control (AGC) for adjusting the levels of received signals within the input dynamic range of the A/D converter.

Since the estimation of a channel impulse response using the above-mentioned long preamble sequences is performed by digital signal processing, AGC must be performed using the signal transmitted before the long-preamble sequence. In the Boer's preamble, AGC is performed using a short-preamble sequence transmitted before the long-preamble sequence from a particular transmit antenna. That is, the receiving level of the short-preamble sequence is measured, and AGC is performed so that the receiving level falls within the input dynamic range of the A/D converter. By virtue of AGC using the short-preamble sequence, the long-preamble sequence and data transmitted from the particular transmit antenna can be received correctly. If all the antennas are arranged apart, the receiving levels of signals transmitted from the antennas are inevitably different from each other. Therefore, when a wireless receiving device receives long-preamble sequences transmitted from the other three transmit antennas, or data transmitted from all the antennas, their receiving levels may be much higher or lower than the level acquired by AGC using the short-preamble sequence transmitted from the particular transmit antenna. When the receiving level exceeds the upper limit of the input dynamic range of the A/D converter, the output of the A/D converter is saturated. On the other hand, when the receiving level is lower than the lower limit of the input dynamic range of the A/D converter, the output of the A/D converter suffers a severe quantization error. In either case, the A/D converter cannot perform appropriate conversion, which adversely influences the processing after A/D conversion.

Further, data is transmitted from all the antennas. Therefore, during data transmission, the range of variations in receiving level is further increased, which worsens the above-mentioned saturation of the A/D converter output and/or the quantization error therein, thereby significantly degrading the receiving performance.

As described above, in the Boer's proposed preamble, AGC is performed at the receive side using only the short-preamble sequence transmitted from a single transmit antenna, which makes it difficult to deal with variations in receiving level that may occur when signals transmitted from the other antennas in MIMO mode are received.

### BRIEF SUMMARY OF THE INVENTION

The first aspect of the present invention provides a wireless transmitting device for use in communication with a wireless receiving device with a wireless packet, comprising: a plurality of antennas; and a signal generator configured to generate a signal for the wireless packet being transmitted, the wireless packet comprising a short-preamble sequence used for a first automatic gain control (1^{st} AGC) at the wireless receiving device, a first long-preamble sequence used for an estimation of a channel impulse response between the wireless transmitting device and the wireless receiving device, a signal field used for conveying information regarding a length of the wireless packet, an AGC preamble sequence used for a second automatic gain control (2^{nd} AGC) which is performed after the first automatic gain control at the receiving device, and transmitted in parallel via the plurality of antennas, a second long-preamble sequence used for estimation of a channel impulse response between the wireless transmitting device and the wireless receiving device, and a data field conveying data, wherein the first signal field includes at least one of (a) a reserve bit for notifying transmission of the AGC preambles, (b) a reserve bit for notifying transmission of the second signal field, the AGC preambles and the data and (c) a reserve bit for notifying transmission of the AGC preambles and the data using the plurality of antennas.

The second aspect of the present invention provides a wireless receiving device comprising: a receiving unit configured to receive a wireless packet to generate a received signal, the packet comprising a short-preamble sequence, a first long-preamble sequence, a first signal field having a reserve bit, and a second signal field, which are sequentially transmitted from one of the plurality of antennas, the signal also including a plurality of AGC preambles and data signals transmitted in parallel via the plurality of antennas after the second signal field is transmitted; a variable-gain amplifier which amplifies the received signal; and a gain controller which controls, upon receiving the reserve bit, a gain of the variable-gain amplifier using the AGC preambles.

The third aspect of the present invention provides a wireless receiving device comprising: a receiving unit configured to receive a wireless packet to generate a received signal, the packet comprising a short-preamble sequence, a first long-preamble sequence, a first signal field having a reserve bit, and a second signal field, which are sequentially transmitted from at least one of the plurality of antennas, the signal also including a plurality of AGC preambles and data signals transmitted in parallel via the plurality of antennas after the second signal field is transmitted; a variable-gain amplifier which amplifies the received signal; a gain controller which controls a gain of the variable-gain amplifier using the AGC preambles; and a start controller which controls the gain controller to start a gain control operation thereof, in response to reception of the reserve bit.

### BRIEF DESCRIPTION OF THE SEVERAL VIEWS OF THE DRAWING

FIG. 1 is a view illustrating a format for a wireless packet including the AGC preambles for wireless communication used in an embodiment of the invention;

FIG. 2 is a view illustrating a wireless packet conforming to IEEE 802.11a;

FIG. 3 is a block diagram illustrating the configuration of a wireless transmitting device according to the embodiment;

FIG. 4 is a block diagram illustrating the configuration of a wireless receiving device according to the embodiment;

FIG. 5 is a block diagram illustrating a configuration example of a receiving unit incorporated in the device of FIG. 4;

FIG. 6 is a block diagram illustrating an example of a digital demodulator incorporated in the device of FIG. 4;

FIG. 7 is a graph illustrating the distribution of the receiving power of short preambles and data in the prior art; and

FIG. 8 is a graph illustrating the distribution of the receiving power of short preambles and data in the embodiment.

### DETAILED DESCRIPTION OF THE INVENTION

Embodiments of the invention will be described in detail with reference to the accompanying drawings.

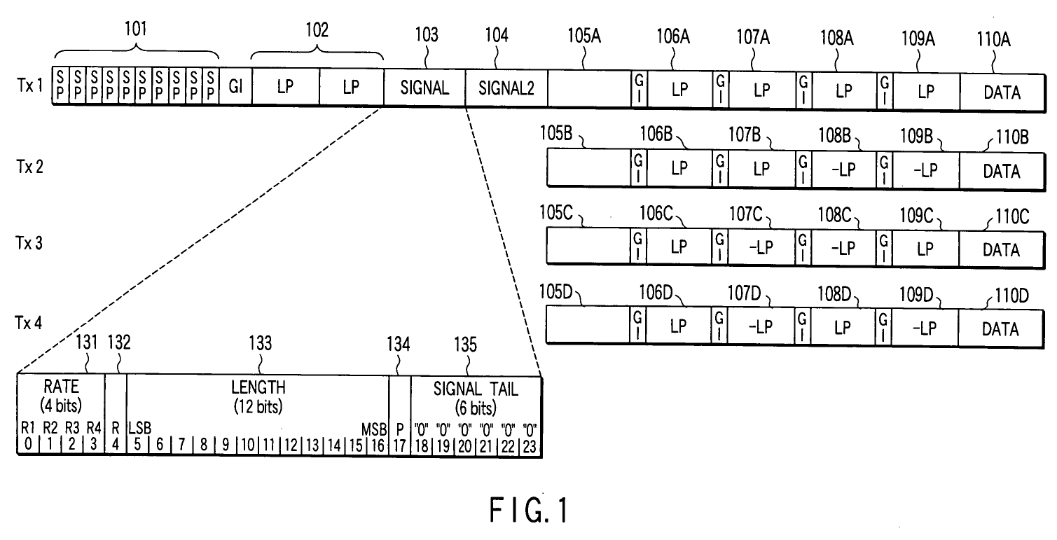

FIG. 1 shows a format for a wireless packet employed in a first embodiment of the invention. This format is a physical layer protocol data unit format for the MIMO mode and provides interoperability and coexistence with IEEE 802.11a wireless stations.

As seen from FIG. 1, a preamble includes a physical layer convergence protocol (PLCP) signal transmitted from an antenna Tx1. The PLCP signal includes a short-preamble sequence 101, first long-preamble sequence 102, first signal field (SIGNAL) 103 and second signal field (SIGNAL 2) 104. The short-preamble sequence 101 contains several unit preambles SP. The long-preamble sequence 102 contains the unit preambles LP having respective predetermined lengths. The unit preambles of LP are longer than those of SP.

The short-preamble sequence 101, first long-preamble sequence 102 and first signal field 103 conform to IEEE 802.11a, while the second signal field 104 is necessary for the new wireless LAN standard IEEE 802.11n. First signal field 103 conforming to IEEE 802.11a may be called “legacy signal field”. Since the second signal field 104 is provided for new high throughput wireless LAN standard, it may be called “high throughput signal field”. A guard interval GI is inserted between the short-preamble sequence 101 and the long-preamble sequence 102.

After the PLCP signal, AGC preambles 105A to 105D that are transmitted in parallel from a plurality of antennas Tx1 to Tx4 are positioned. The AGC preambles 105A to 105D are transmitted simultaneously from a plurality of antennas Tx1 to Tx4. The AGC preambles 105A to 105D are used to enable the receiving device to perform fine AGC when performing MIMO communication. These preambles are unique to perform fine tune the AGC for reception of MIMO mode in accordance with IEEE 802.11n. Therefore, the AGC preambles 105A to 105D may be called “high throughput short trainings field”. On the other hand, since the short-preamble sequence 101 conforms to IEEE 802.11a, being used for coarse AGC operation, it may be called “legacy short training field”.

After the AGC preambles 105A to 105D, second long-preamble sequences 106A to 109A, 106B to 109B, 106C to 109C and 106D to 109D are positioned. In the embodiment, the same signal sequences are used as the AGC preambles 105A to 105D. However, different signal sequences may be used as the AGC preambles 105A to 105D. A guard interval GI is inserted between each pair of adjacent ones of the unit preambles LP that form the second long-preamble sequences 106A to 109A, 106B to 109B, 106C to 109C and 106D to 109D. The second long-preamble sequences 106A to 109A, 106B to 109B, 106C to 109C and 106D to 109D sequences are in the orthogonal relationship in this embodiment. But, they are not limited in the orthogonal relationship. The number of unit preambles LP 106-109 for each transmit antenna is equal to the number of transmit antennas in MIMO mode. In order to distinguish between two kinds of long-preamble sequences, first long-preamble sequence 102 conforming to IEEE 802.11a may be called “legacy long training field”. Since the second long preambles sequences 106-109 are provided for new high throughput wireless LAN standard, it may be called “high throughput long training field”.

After each of the second long-preamble sequences 106A to 109A, 106B to 109B, 106C to 109C and 106D to 109D, a field for transmission data (DATA) 110A to 110C transmitted from the antennas Tx1 to Tx4, respectively, is positioned. The second long-preamble sequences 106A to 109A, 106B to 109B, 106C to 109C and 106D to 109D are transmitted simultaneously from a plurality of antennas Tx1 to Tx4 respectively. Before the first signal field 103, the second signal field 104 will be described. The second signal field 104 contains identification information indicating that the radio packet shown in FIG. 1 conforms to IEEE 802.11n different from IEEE 802.11a. In other words, the second signal field 104 indicates that the second long-preamble sequences 106A to 109A, 106B to 109B, 106C to 109C and 106D to 109D are to be received next, and that the number of symbols included in the second long-preamble sequences. The field 104 also indicates that a modulation and coding scheme (MCS) which is the combination of the modulation and coding schemes of the transmission data 110A to 110D. The coding scheme indicates the coding rate of a convolution code as an error correction signal.

The first signal field 103 will now be described in detail. The field 103 contains information indicating the modulation scheme and radio packet length of the following transmission data 110A to 110D. As mentioned above, in the radio communication preamble signal shown in FIG. 1, the PLCP signal zone, in particular, the radio packet zone ranging from the short-preamble sequence 101 to the first signal field 103, conforms to IEEE 802.11a.

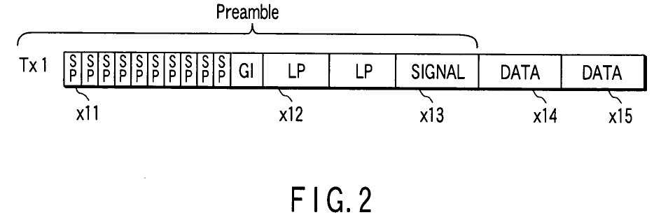

FIG. 2 shows a wireless packet based on IEEE 802.11a. In this case, from a single transmission antenna Tx1, a short-preamble sequence x11 used for time synchronization, frequency synchronization and AGC, a long-preamble sequence x12 for channel response estimation, and a signal field x13 including a field indicating the modulation scheme and length of the wireless packet are transmitted. After that, transmission data items x14 and x15 are transmitted from the antenna Tx1.

The first signal field 103 shown in FIG. 1 is similar to the signal field x13 of the wireless packet based on IEEE 802.11a and shown in FIG. 2. As shown in detail in FIG. 1, the first signal field 103 comprises a rate section (RATE) 131 indicating a modulation and coding Scheme (MCS) of a data signal in a wireless packet based on IEEE 802.11a, a reserve bit (R) 132 reserved for future standard extension, and a packet length section (LENGTH) 133 indicating the length of the wireless packet. The field 103 also comprises a parity section (P) 134 that performs parity checking of information ranging from the rate section 131 to the packet length section 133, and a signal tail section (SIGNAL TAIL) 135 for terminating a convolution code. These sections are combined by OFDM multiplexing and transmitted from the transmission antenna Tx1.

Accordingly, if the wireless device conforms to IEEE 802.11a, it can perform normal receiving operations within the wireless packet zone indicated by the packet length section 133. Namely, the wireless packet is protected from being destroyed by another wireless transmission device, which conforms to IEEE 802.11a, starting transmission within the signal zone following the first signal field 103.

The reserve bit 132 is not necessary for wireless device conforming to IEEE 802.11a and hence ignored at the receiver device. The embodiment controls, using the reserve bit 132, the operation of a wireless device based on a standard other than IEEE 802.11a, i.e., for example, IEEE 802.11n. Specifically, for example, the reserve bit 132 (a) beforehand notifies the transmission of the AGC preambles 105A to 105D, and (b) indicates the transmission of a wireless packet corresponding to IEEE 802.11n shown in FIG. 1. Further, the reserve bit 132 (c) beforehand notifies the transmission of the AGC preambles 105A to 105D and data items 110A to 110D performed by a plurality of transmission antennas 205A to 205D, and (d) notifies the transmission of the second signal field 104.

The notification (a) includes indirect notification of the transmission of the AGC preambles 105A to 105D by beforehand notifying the transmission of the second signal field 104. The wireless packet corresponding to IEEE 802.11n, recited in (b), indicates a wireless packet that includes the short-preamble sequence 101, first long-preamble sequence 102, first signal field 103, second signal field 104, AGC preambles 105A to 105D, second long-preamble sequences 106A to 109A, 106B to 109B, 106C to 109C and 106D to 109D, and data items 110A to 110D. That is, the wireless packet includes signals transmitted from a plurality of transmission antennas and combined by multiplexing using MIMO.

If transmission is performed with the reserve bit 132 set to, for example, “1”, a wireless device conforming to IEEE 802.11n receives and demodulates the reserve bit 132, thereby recognizing the reception of a wireless packet corresponding to IEEE 802.11n. More specifically, the reserve bit 132 can indicate the reception of the wireless packet shown in FIG. 1, and indicate that the second signal field and AGC preambles 105A to 105D will be received after the reserve bit 132.

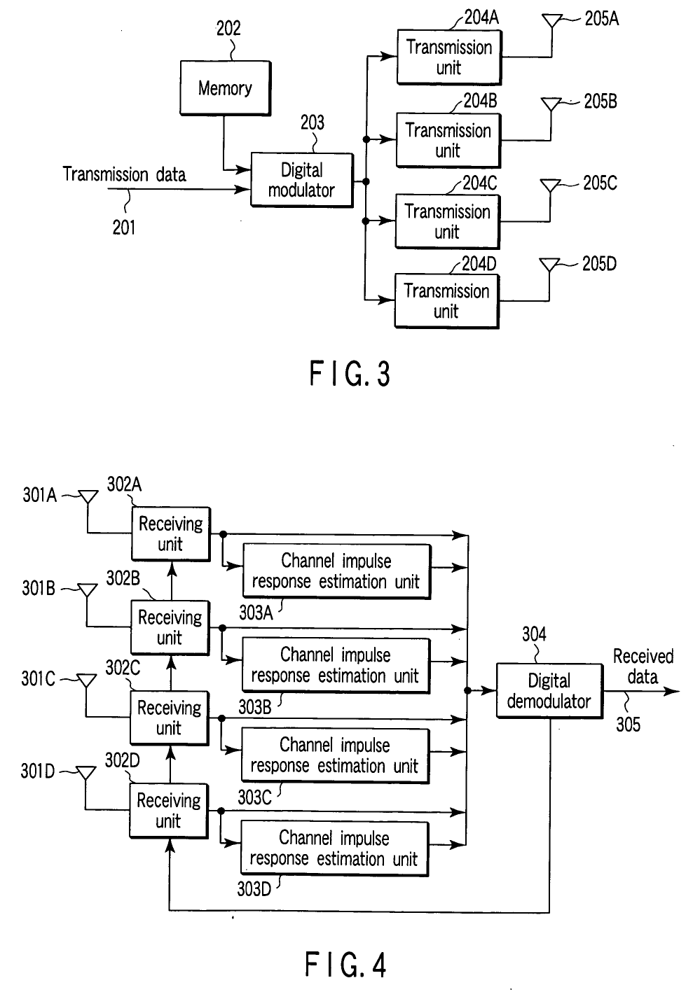

Referring now to FIG. 3, the wireless transmitting device according to the embodiment will be described. Firstly, digital modulator 203 forms a signal for wireless packet by combining transmission data 201 and the above-described preamble outputted from a memory 202. The thus-obtained signal for wireless packet is sent to transmitting units 204A to 204D, where they are subjected to processing needed for transmission, for example, digital-to-analog (D/A) conversion, frequency conversion into a radio frequency (RF) band (up-conversion) and power amplification. Thereafter, the resultant signal is sent to a plurality of antennas 205A to 205D corresponding to the antennas Tx1 to Tx4 described with reference to FIG. 1, where an RF signal is sent from each transmit antenna 205A to 205D to the wireless receiving device shown in FIG. 4. In the description below, the antennas Tx1 to Tx4 shown in FIG. 1 are referred to as the antennas 205A to 205D, respectively.

In the embodiment, the PLCP signal shown in FIG. 1, which includes the short-preamble sequence 101, first long-preamble sequence 102, first signal field 103 and second signal field 104, is transmitted from the transmit antenna 205A of the transmission unit 204A shown in FIG. 2. The AGC preambles 105A to 105D, second long-preamble sequences 106A to 109A, 106B to 109B, 106C to 109C and 106D to 109D, which are positioned after the PLCP signal as shown in FIG. 1, and the data 110A to 110D are transmitted across all the transmit antennas 205A to 205D shown in FIG. 3. In the wireless receiving device shown in FIG. 4, a plurality of receiving antennas 301A to 301D receive RF signals transmitted from the wireless transmitting device shown in FIG. 3. The wireless receiving device may have one receiving antenna or multiple receiving antennas. The RF signals received by the receiving antennas 301A to 301D are sent to receiving units 302A to 302D, respectively. The receiving units 302A to 302D each perform various types of receiving processing, such as frequency conversion (down-conversion) from the RF band to BB (baseband), automatic gain control (AGC), analog-to-digital conversion, etc., thereby generating a baseband signal.

The baseband signals from the receiving units 302A to 302D are sent to channel impulse response estimation units 303A to 303D and digital demodulator 304. These units 303A to 303D estimate the impulse responses of the respective propagation paths between the wireless transmitting device of FIG. 3 and the wireless receiving device of FIG. 4. The channel impulse response estimation units 303A to 303D will be described later in detail. The digital demodulator 304 demodulates the baseband signals based on the estimated channel impulse response provided by units 303A to 303D, thereby generating received data 305 corresponding to the transmission data 201 shown in FIG. 3.

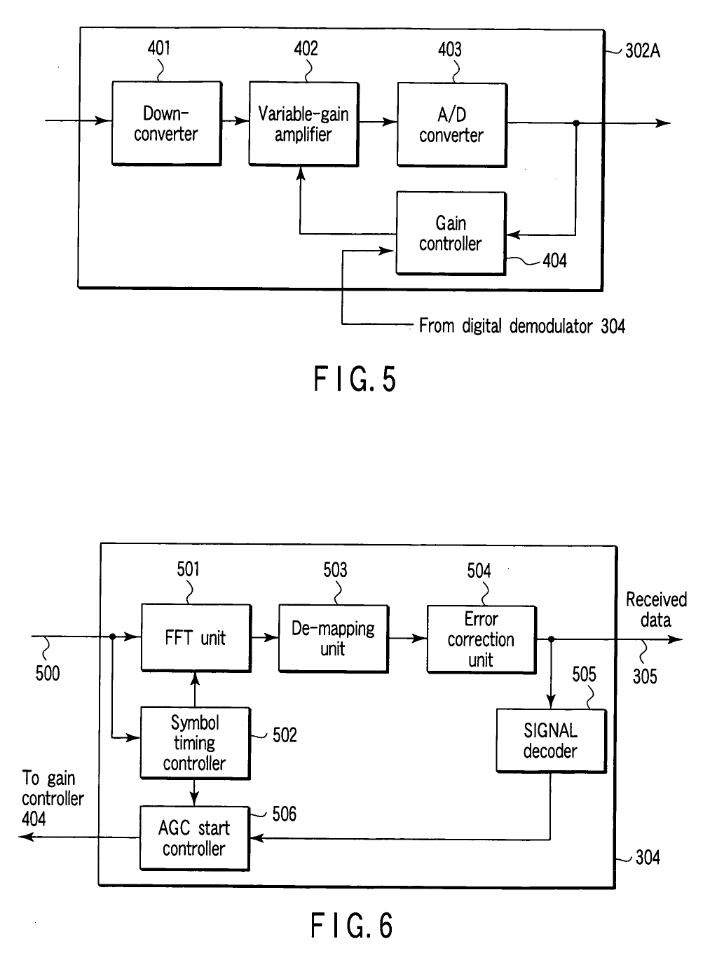

More specifically, the digital demodulator 304 has an equalizer of the channel impulse response at its input section. The equalizer performs equalization for correcting the received signal distorted in the propagation path, based on the estimated channel impulse response. The digital demodulator 304 also demodulates the equalized signal at appropriate timing determined by the time synchronization, thereby reproducing data. The receiving units 302A to 302D shown in FIG. 4 will now be described. FIG. 5 shows the configuration of the receiving unit 302A in detail. Since the other receiving units 302B to 302D have the same configuration as the unit 302A, only the receiving unit 302A will be described. The RF received signal received by the receiving antenna 301A is down-converted by a down-converter 401 into a baseband signal. At this time, The RF signal may be directly converted into a baseband signal, or may be firstly converted into an intermediate frequency (IF) signal and then into a baseband signal.

The baseband signal generated by the down-converter 401 is sent to a variable gain amplifier 402, where it is subjected to perform AGC, i.e., signal level adjustment. The signal output from the variable gain amplifier 402 is sampled and quantized by an A/D converter 403. The digital signal output from the A/D converter 403 is sent to the outside of the receiving unit 302 and to a gain controller 404. The gain controller 404 performs gain calculation based on the digital signal output from the A/D converter 403, and controls the gain of the variable gain amplifier 402. The specific procedure for the gain control will be described later.

The operation of the wireless receiving device shown in FIGS. 4 and 5 executed for receiving the wireless packet including the preamble whose format is shown in FIG. 1 is as follows. Firstly, the wireless receiving device receives a short-preamble sequence 101 transmitted from the transmit antenna 205A of FIG. 3, and then performs packet edge detection, time synchronization, auto frequency control (AFC) and AGC, using a baseband signal corresponding to the short-preamble sequence 101. AFC is also called frequency synchronization. Packet edge detection, time synchronization and AFC can be performed using known techniques, therefore no description will be given thereof. Only AGC will be explained below.

The baseband signal corresponding to the short-preamble sequence 101 is amplified by the variable gain amplifier 402 in accordance with a predetermined initial gain value. The signal output from the variable gain amplifier 402 is input to the gain controller 404 via the A/D converter 403. The gain controller 404 calculates a gain from the level of the received signal corresponding to the short-preamble sequence 101, which is acquired after A/D conversion, and controls the gain of the variable gain amplifier 402 in accordance with the calculated gain.

Assume here that the level of the baseband signal corresponding to the short-preamble sequence 101, which is acquired before A/D conversion, is X. If level X is high, the baseband signal input to the A/D converter 403 exceeds the upper limit of the input dynamic range of the A/D converter 403. As a result, the signal (digital signal) output from the A/D converter 403 is saturated and degraded the quality of signal reception. On the other hand, if level X is extremely low, the signal output from the A/D converter 402 (i.e., the digital signal acquired by A/D conversion) suffers a severe quantization error. Thus, when level X L is very high or low, the A/D converter 403 cannot perform appropriate conversion, thereby significantly degrading the quality of signal reception.

To overcome this problem, the gain controller 404 controls the gain of the variable gain amplifier 402 so that the level X of the baseband signal corresponding to the short-preamble sequence 101, is adjusted to a target value Z. If the input baseband signal has such a very high level as makes the output of the A/D converter 403 limited to its upper limit level, or if it has a very low level, the gain of the variable gain amplifier 402 may not appropriately be controlled by one control process. In this case, gain control is performed repeatedly. As a result, the level of the baseband signal input to the A/D converter 403 can be adjusted to a value that falls within the input dynamic range of the A/D converter 403. Thus, the gain of the variable gain amplifier 402 is appropriately controlled using the baseband signal corresponding to the short-preamble sequence 101, thereby performing appropriate A/D conversion to avoid a reduction in the quality of signal reception.

In the above-described embodiment, the reception level needed for calculating the gain of the variable gain amplifier 402 is measured using a digital signal output from the A/D converter 403. However, such level measurement can be executed using an analog signal acquired before A/D conversion. Furthermore, the reception level may be measured in the IF band or RF band, instead of BB.

The wireless receiving device receives a first long-preamble sequence 102 transmitted from the transmit antenna 205A, and performs the estimation of channel impulse response, i.e., estimates the response (frequency transfer function) of the propagation path between the wireless transmitting device to the wireless receiving device, using a baseband signal corresponding to the long-preamble sequence 102. Since the signal transmitted from the transmit antenna 205A has already been subjected to AGC as described above, the level of an input to the A/D converter 403 is appropriately adjusted when the estimation of channel impulse response is performed. Accordingly, concerning the signal transmitted from the transmit antenna 205A, a highly accurate digital signal is acquired from the A/D converter 403. The estimation of channel impulse can be performed accurately with the acquired digital signal.

The wireless receiving device receives a first signal field 103 transmitted from the transmit antenna 205A, and demodulates a baseband signal corresponding to the first signal field 103, using the digital demodulator 304 and the above-mentioned channel estimation result. As shown in FIG. 1, the first signal field 103 contains the rate section 131 indicating the MCS of a data signal following preamble data, and the packet length section 133 indicating the length of the wireless packet. In the wireless packet zone recognized from the packet length section 133 of the first signal field 103, the wireless receiving device causes the digital demodulator 304 to continue decoding processing.

Referring to FIG. 6, the digital demodulator 304 shown in FIG. 4 will be described in detail. The digital demodulator 304 receives signals 500 from the receiving units 302A to 302D shown in FIG. 4. The digital demodulator 304 comprises a fast Fourier transform (FFT) unit 501, symbol timing controller 502, de-mapping unit 503, error correction unit 504, signal decoder 505 and AGC start controller 506.

The symbol timing controller 502 performs symbol synchronization included in timing synchronization, using the input short-preamble sequence 101, long-preamble sequence 102, etc. Specifically, the end of each symbol in the wireless packet shown in FIG. 1 is recognized. Since symbol synchronization is performed by a known method, no detailed description will be given of the method.

The FFT unit 501 performs FFT on the input signal 500 in accordance with the timing recognized by the symbol timing controller 502, thereby performing channel response estimation using the first long-preamble sequence 102. Propagation path estimation is also a known technique, therefore no description will be given thereof.

After that, the FFT unit 501 performs FFT on the input signal 500 in synchronism with the first signal field 103. The output of the FFT unit 501 is input to the error correction unit 504 after it is converted into a binary-value sequence by the de-mapping unit 503. The output of the error correction unit 504 is output as received data 305 from the digital demodulator 304 to the signal decoder 505. Alternatively, the output of the de-mapping unit 503 can be directly input to the signal decoder 505, without using the error correction unit.

The signal decoder 505 is provided for decoding the first signal field 103. When the signal decoder 505 decodes the reserve bit 132 in the first signal field 103 and detects that it is a preset value, e.g. “1”, it recognizes that the AGC preambles 105A to 105D will be received soon, and informs the AGC start controller 506 of this, i.e., a previous notice of reception of the AGC preambles. Upon receiving the previous notice, the AGC start controller 506 supplies an AGC start command to the gain controller 404 shown in FIG. 5, thereby causing the gain controller 404 to start gain control.

After receiving the second signal field 104 from the transmission antenna 205A, the wireless receiving device receives the AGC preambles 105A to 105D from the transmission antennas 205A to 205D. The AGC preambles 105A to 105D are transmitted from the transmission antenna 205A that has transmitted so far the previous signals, and from the transmission antennas 205B to 205D that have not yet transmitted any signals. Accordingly, the AGC preambles 105A to 105D are received with different received-signal levels, which differs from the signals (first short-preamble sequence 101, second long-preamble sequence 102, first signal 103 and second signal 104) transmitted with the almost same received-signal level from the transmission antenna 205A.

At this time, the AGC start controller 506 already has the previous notice of the reception of the AGC preambles 105A to 105D issued by the signal decoder 505. Therefore, it supplies, based on symbol timing information from the symbol timing controller 502, the receiving units 302A to 302D with another AGC start command when the AGC preambles pass through the A/D converter 403 in FIG. 5. Upon receiving the AGC start command, the receiving units 302A to 302D again perform AGC using the AGC preambles 105A to 105D. As a result, the signals supplied from the transmission antennas 205A to 205D, i.e., the signals transmitted through MIMO channels, can be appropriately adjusted and input to the respective A/D converters 403.

The second AGC start command may be issued after the second signal field 104 is decoded. However, in the embodiment, the second AGC start command is issued after the reserve bit 132 of the first signal field 103 is decoded. This enables a sufficient time to be held before AGC is actually started in response to the AGC start signal. Specifically, a margin can be imparted by the time required to decode the second signal field 104. Accordingly, compared to the case where the AGC start command is output after the second signal field 104 is decoded, the speed of decoding can be reduced and hence more inexpensive LSIs can be provided. Further, since AGC using the AGC preambles 105A to 105D can be performed within a longer time than in the case where the AGC start command is output after the second signal field 104 is decoded, high-quality signals can be received under the control using appropriate AGC values. In other words, gain control for the variable-gain amplifier 402 is performed again using the signal levels acquired after baseband signals corresponding to the AGC preambles 105A to 105D are A/D converted as shown in FIG. 4.

In the preamble proposed by Jan Boer, which is described before, AGC is performed only using a short-preamble sequence (legacy short preamble), transmitted from a single transmit antenna. AGC is performed using a reception level with which the signal transmitted from the antenna where the short-preamble sequence transmits. When a wireless receiving device receives signals transmitted from other three antennas, the device executes gain control by using the acquired gain.

FIG. 7 is a graph illustrating the distribution of the receiving power of a short preamble and data, acquired when Jan Boer's proposed preamble is utilized. The channel is in a multipath environment with a delay spread of 50 nsec (the duration for one data symbol is 4 μsec). As is evident from this figure, the ratio of the receiving level of short preamble (legacy short preamble) to the receiving level of the data varies significantly.

In, for example, region A in FIG. 7, the short preamble is received with a high receiving level, although the receiving level of data is low. Accordingly, if AGC is adjusted in accordance with the receiving power of the short preamble, the receiving power of the data is lower than the receiving power of the short preamble, resulting in a quantization error in the A/D converter 403. In region B in FIG. 7, the short preamble is received with a low receiving level, although the receiving level of data is high. Accordingly, if AGC is adjusted in accordance with the receiving power of the short preamble, the output of the A/D converter when data is input is saturated. Thus, it is understood that since, in the conventional scheme, the receiving power ratio of data to the short-preamble is not constant; the receiving characteristic is degraded because of a quantization error or saturation in the output of the A/D converter.

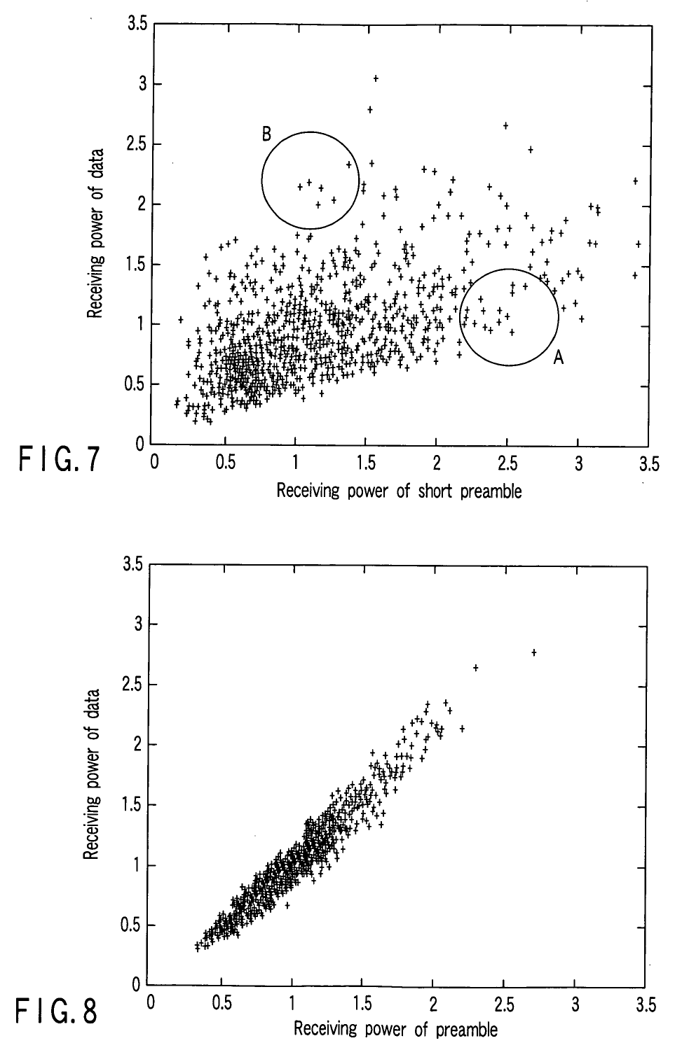

On the other hand, in the embodiment, all antennas 205A to 205D that transmit data signals transmit AGC preambles 105A to 105D, respectively. FIG. 8 shows the distribution of the receiving power of the short-preambles and data, according to the embodiment. The channel environment is the same as in the case of FIG. 7.

As shown in FIG. 8, the receiving power of the AGC preambles is substantially proportional to that of the data 110A to 110D. This indicates that the input level of the A/D converter is adjusted so appropriate that the receiving accuracy is remarkably enhanced as compared to the FIG. 7.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A wireless transmitting device for use in communication with a wireless receiving device with a wireless packet, comprising:
a plurality of antennas; and
a signal generator configured to generate a signal for the wireless packet being transmitted, the wireless packet comprising
a short-preamble sequence used for a first automatic gain control (1^{st} AGC) at the wireless receiving device,
a first long-preamble sequence used for an estimation of a channel impulse response between the wireless transmitting device and the wireless receiving device,
a signal field used for conveying information regarding a length of the wireless packet,
an AGC preamble sequence used for a second automatic gain control (2^{nd} AGC) which is performed after the first automatic gain control at the receiving device, and transmitted in parallel via the plurality of antennas,
a second long-preamble sequence used for estimation of a channel impulse response between the wireless transmitting device and the wireless receiving device, and
a data field conveying data,
wherein the first signal field includes at least one of (a) information for notifying transmission of the AGC preambles, (b) information for notifying transmission of the second signal field, the AGC preambles and the data and (c) information for notifying transmission of the AGC preambles and the data using the plurality of antennas.

2. The wireless transmitting device according to claim 1, wherein the signal field comprises:
a first signal field indicating that the short-preamble sequence and the first long-preamble sequence conform to IEEE 802.11a.

3. The wireless transmitting device according to claim 1, wherein the signal field comprises:
a first signal field conforming to IEEE 802.11a; and
a second signal field indicating that the AGC preamble sequence and the second long-preamble sequence conform to a standard other than IEEE 802.11a.

4. The wireless transmitting device according to claim 1, wherein the wireless packet further comprises a second long-preamble sequence to be transmitted using at least one of the plurality of antennas, after the AGC preambles are transmitted and before the data is transmitted.

5. A wireless receiving device comprising:
a receiving unit configured to receive a wireless packet to generate a received signal, the packet comprising a short-preamble sequence, a first long-preamble sequence, a first signal field and a second signal field, which are sequentially transmitted from at least one of the plurality of antennas, the signal also including a plurality of AGC preambles and data signals transmitted in parallel via the plurality of antennas after the second signal field is transmitted;
a variable-gain amplifier which amplifies the received signal; and
a gain controller which controls, upon receiving information included in the first signal field, a gain of the variable-gain amplifier using the AGC preambles.

6. The wireless receiving device according to claim 5, wherein the information is used for notifying transmission of the AGC preambles.

7. The wireless receiving device according to claim 5, wherein the information is used for notifying transmission of the second signal field, the AGC preambles and the data.

8. The wireless receiving device according to claim 5, wherein the information is used for notifying transmission of the AGC preambles and the data using the plurality of antennas.

9. The wireless receiving device according to claim 5, further comprising an analog-to-digital converter which converts, into a digital signal, a signal output from the variable-gain amplifier.

10. A wireless receiving device comprising:
a receiving unit configured to receive a wireless packet to generate a received signal, the packet comprising a short-preamble sequence, a first long-preamble sequence, a first signal field and a second signal field, which are sequentially transmitted from at least one of the plurality of antennas, the signal also including a plurality of AGC preambles and data signals transmitted in parallel via the plurality of antennas after the second signal field is transmitted;
a variable-gain amplifier which amplifies the received signal;
a gain controller which controls a gain of the variable-gain amplifier using the AGC preambles; and
a start controller which controls the gain controller to start a gain control operation thereof, in response to reception of the first signal field.

11. The wireless receiving device according to claim 10, wherein the first signal field is used for notifying transmission of the AGC preambles.

12. The wireless receiving device according to claim 10, wherein the first signal field is used for notifying transmission of the second signal field, the AGC preambles and the data.

13. The wireless receiving device according to claim 10, wherein the first signal field is used for notifying transmission of the AGC preambles and the data using the plurality of antennas.

14. The wireless receiving device according to claim 10, further comprising an analog-to-digital converter which converts, into a digital signal, a signal output from the variable-gain amplifier.
